(19) United States
(12) Patent Application Publication
(10) Pub. No.: US 2015/0104764 A1
(43) Pub. Date: Apr. 16, 2015

(54) ADAPTIVE GRAMMAR INSTRUCTION FOR COMMAS

(71) Applicant: Apollo Education Group, Inc., Phoenix, AZ (US)

(72) Inventors: Robert Murray, Edgewood, PA (US); Linda Schmandt, Pittsburgh, PA (US); Ryan Schwiebert, Pittsburgh, PA (US); Sara Hinton, Atlanta, GA (US); Scott Fraundorf, Rochester, NY (US); Alison Huettner, Pittsburgh, PA (US); Pete Shell, Pittsburgh, PA (US)

(21) Appl. No.: 14/460,167

(22) Filed: Aug. 14, 2014

Related U.S. Application Data
(60) Provisional application No. 61/890,875, filed on Oct. 15, 2013.

(51) Int. Cl. G09B 7/00; G06F 17/28; G09B 19/00; G06F 3/0484; G06F 17/24; G06F 17/27; G06F 3/0481

(52) U.S. Cl. CPC G09B 7/00; G06F 17/274; G06F 17/28; G06F 3/0481; G06F 3/04842; G06F 17/24; G09B 19/00
USPC 434/169

(57) ABSTRACT

Techniques are described for an automated grammar teaching system that displays sentences and allows a user to identify comma errors within the sentences, if any. The sentences may be presented as a set of sentences or a paragraph. When presented as a set, the sentences may employ similar or contrasting sentence structures to emphasize the application of the comma rules. The user may be asked to determine whether the sentences are correct or incorrect, to identify the locations of missing or extraneous commas, and in a sentence with a coordinating conjunction, to determine whether the conjunction joins two independent clauses. To guide the user, multi-level hints may be provided on request, and an incorrect user response may trigger the display of remediation information or a just-in-time hint. New sentences in the teaching system may be selected based on historical data maintained for the user.

### CROSS-REFERENCE TO RELATED APPLICATIONS; BENEFIT CLAIM

This application claims the benefit of U.S. Provisional Application No. 61/890,875, filed Oct. 15, 2013, which is hereby incorporated by reference in its entirety for all purposes as if fully set forth herein.

### FIELD OF THE INVENTION

The present invention relates to teaching natural language punctuation conventions, and, more specifically, to an adaptive grammar teaching system configured to train users on identifying and correcting punctuation errors within natural language sentences.

### BACKGROUND

Natural languages are spoken languages (such as American English), which have grammar rules governing the composition of the natural language. There are stylistic conventions that apply to the written form of a natural language, which, unlike natural language per se, must be taught. When a person has not learned the proper stylistic conventions for written language, the student may encounter difficulty in communicating in writing, particularly in formal documents. For example, it may be particularly difficult for a person who does not understand the punctuation rules of American English to write an error-free research paper or formal letter, which limits that person's ability to communicate effectively through writing.

Grammar checkers, e.g., Grammerly.com, Thelma Thistleblossom, and grammar checkers included with document editors such as Microsoft Word, identify certain types of grammatical and punctuation errors in written documents. However, grammar and punctuation error identification/correction is not the same as teaching grammar and punctuation rules, even when the grammar checker indicates why each identified error is an error. Grammar checkers generally do not teach either prescriptive or descriptive rules of grammar, nor do grammar checkers target particular problems that users have with grammatical or stylistic rules. At times, the grammar checkers identify “errors” that are not errors at all, and rely on the user's knowledge to ultimately determine whether an error exists. Thus, grammar checkers are generally ineffective at teaching a user the conventions of formal written language.

Some English courses, e.g., in secondary and higher education, attempt to teach prescriptive grammar rules, largely using face-to-face teaching techniques, quizzes, and other activities. At times, automation is used in such traditional English courses. However, this automation generally consists of providing a student with multiple-choice questions and giving the student feedback on the student's selected answers. It can be difficult for an English teacher to identify and aid each student with the student's individual grammar or stylistic misconceptions, especially since classes tend to be large and students tend to have a wide range of skill gaps with respect to mastery of prescriptive grammar rules. At least the above mentioned deficiencies can allow students to complete English courses without learning all of the prescriptive grammar rules that they need to produce error-free communications.

Therefore, it would be beneficial to provide an automated grammar teaching system that is configured to teach prescriptive stylistic conventions targeted to the needs of students.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example network arrangement for an automated grammar teaching system that adaptively instructs a user regarding grammar rules governing commas in sentences.

FIG. 2 depicts a flowchart for receiving input information from a user identifying comma errors in a displayed set of natural language sentences.

FIG. 3 depicts a graphical user interface configured to allow a user to identify, within a displayed set of sentences, comma errors.

FIG. 4 depicts a flowchart for receiving input information from a user identifying a correction of a comma error in a displayed natural language sentence and determining whether the correction is accurate.

FIG. 5 depicts a graphical user interface configured to allow a user to identify a correction of a comma error within a displayed sentence and to display remediation information about an inaccurate correction, by a user, of a comma error.

FIG. 6 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

An automated grammar teaching system delivers highly personalized, differentiated instruction to users. The automated grammar teaching system provides lessons and adaptive practice to build each student's skills for the rules of natural language grammar with respect to commas. Comma problems, constructed to address each students' continuous learning needs with respect to granular grammar skills relating to commas, are automatically presented to students by the automated grammar teaching system.

In an initial phase, focused sections of problems are presented to the user in a user interface. The problems are formatted using contrasting sentence sets that are designed to emphasize the correct application of comma rules in different sentence contexts and scenarios. The user is asked to identify whether each of the set of sentences is correct with respect to comma usage. Each focused section is based on a particular subset of comma rules, allowing the user to master the various comma rules in a logically separated and manageable fashion.

In a later phase, a capstone section of problems is presented to the user in the user interface. The problems are formatted as subsets of paragraphs with various types of comma errors from the prior focused sections. The user is asked to identify the presence of comma errors, the specific locations of the comma errors, and the necessary corrections.

In an embodiment, if a user incorrectly identifies a particular portion or an entirety of a sentence as having a comma error, then the system displays remediation information to help the user understand why the identification is incorrect. In an embodiment, if a user provides an inaccurate correction to a comma error, the system displays remediation information to explain why the correction that the user specified is inaccurate. Further, the automated grammar teaching system records, as historical data, a user's actions within the system. The system uses this historical data to identify what sentences, with what kinds of comma errors, the system should provide to the user.

### Adaptive Grammar Instructions Architecture

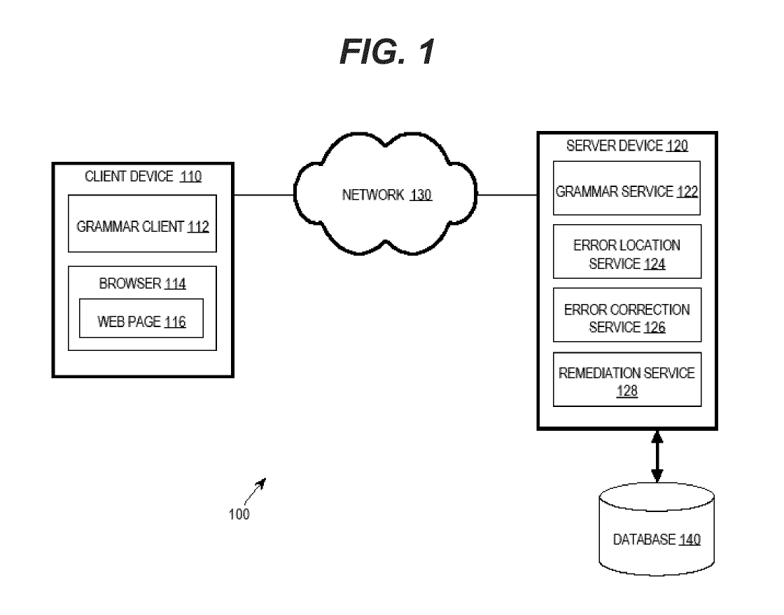

Techniques are described hereafter for adaptively instructing a user on grammar rules governing comma usage in sentences. FIG. 1 is a block diagram that depicts an example network arrangement 100 for an automated grammar teaching system that adaptively instructs a user regarding grammar rules governing comma usage in sentences, according to embodiments. Network arrangement 100 includes a client device 110 and a server device 120 communicatively coupled via a network 130. Server device 120 is also communicatively coupled to a database 140. Example network arrangement 100 may include other devices, including client devices, server devices, and display devices, according to embodiments. For example, one or more of the services attributed to server device 120 herein may run on other server devices that are communicatively coupled to network 130. In alternative embodiments, network 130 may not be utilized. For example, client device 110, server device 120, and database 140 may be consolidated into a single standalone workstation.

With respect to FIG. 1, server device 120 may correspond to server device 120 from FIG. 1.1 of the parent provisional application, as described in Section 1.0 of the parent provisional application. Accordingly, additional services such as mastery tracking service 124 and hint service 126 from service device 120 in FIG. 1.1 of the parent provisional application may also be included in server device 120 of FIG. 1.

Client device 110 may be implemented by any type of computing device that is communicatively connected to network 130. Example implementations of client device 110 include, without limitation, workstations, personal computers, laptop computers, personal digital assistants (PDAs), tablet computers, cellular telephony devices such as smart phones, and any other type of computing device.

In network arrangement 100, client device 110 is configured with a grammar client 112 and a browser 114 that displays web page 116. Grammar client 112 may be implemented in any number of ways, including as a plug-in to browser 114, as an application running in connection with web page 116, as a stand-alone application running on client device 110, etc. Grammar client 112 may be implemented by one or more logical modules, and is described in further detail below. Browser 114 is configured to interpret and display web pages that are received over network 130 (e.g., web page 116), such as Hyper Text Markup Language (HTML) pages, and eXtensible Markup Language (XML) pages, etc. Client device 110 may be configured with other mechanisms, processes and functionalities, depending upon a particular implementation.

Further, client device 110 is communicatively coupled to a display device (not shown in FIG. 1), for displaying graphical user interfaces, such as graphical user interfaces of web page 116. Such a display device may be implemented by any type of device capable of displaying a graphical user interface. Example implementations of a display device include a monitor, a screen, a touch screen, a projector, a light display, a display of a tablet computer, a display of a telephony device, a television, etc.

Network 130 may be implemented with any type of medium and/or mechanism that facilitates the exchange of information between client device 110 and server device 120. Furthermore, network 130 may facilitate use of any type of communications protocol, and may be secured or unsecured, depending upon the requirements of a particular embodiment.

Server device 120 may be implemented by any type of computing device that is capable of communicating with client device 110 over network 130. In network arrangement 100, server device 120 is configured with a grammar service 122, an error location service 124, an error correction service 126, and a remediation service 128. One or more of services 122-128 may be part of a cloud computing service. Functionality attributed to one or more of services 122-128 may be performed by grammar client 112, according to embodiments. Services 122-128 may be implemented by one or more logical modules, and are described in further detail below. Server device 120 may be configured with other mechanisms, processes and functionalities, depending upon a particular implementation.

Server device 120 is communicatively coupled to database 140. Database 140 may reside in any type of storage, including volatile and non-volatile storage (e.g., random access memory (RAM), one or more hard or floppy disks, main memory, etc.), and may be implemented by multiple logical databases. The storage on which database 140 resides may be external or internal to server device 120.

Any of grammar client 112 and services 122-128 may receive and respond to Application Programming Interface (API) calls, Simple Object Access Protocol (SOAP) messages, requests via HyperText Transfer Protocol (HTTP), HyperText Transfer Protocol Secure (HTTPS), Simple Mail Transfer Protocol (SMTP), or any other kind of communication, e.g., from one of the other services 122-128 or grammar client 112. Further, any of grammar client 112 and services 122-128 may send one or more of the following over network 130 to one of the other entities: information via HTTP, HTTPS, SMTP, etc.; XML data; SOAP messages; API calls; and other communications according to embodiments.

In an embodiment, each of the processes described in connection with one or more of grammar client 112 and services 122-128 are performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

### Sentence Problems Stored at the Database

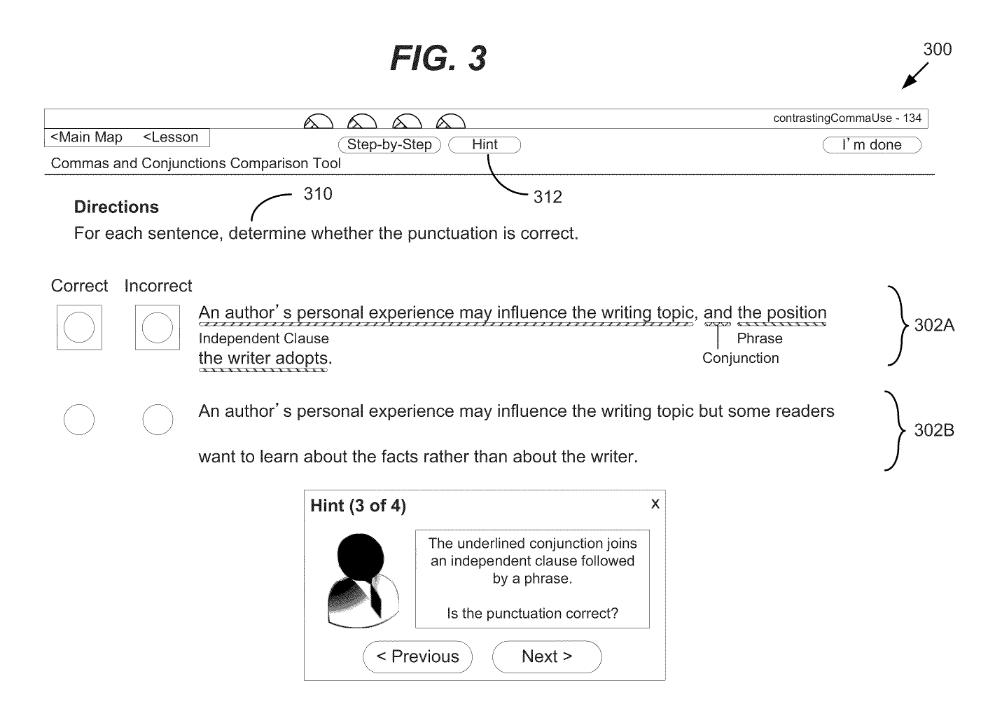

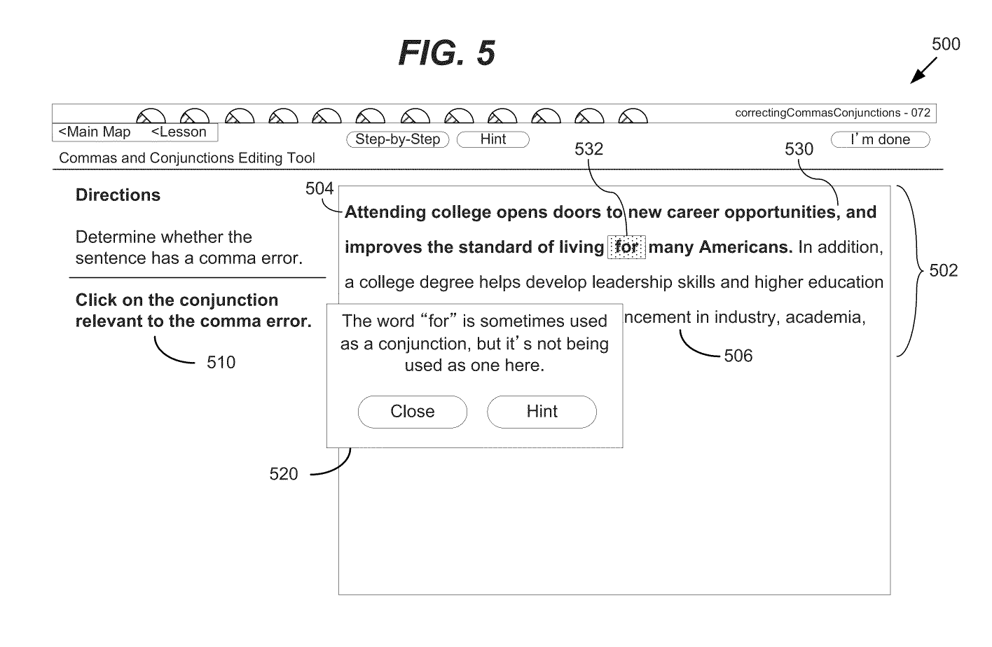

According to embodiments, a comma problem includes either (a) a sentence list of two or more sentences, such as a pair of sentences illustrated in GUI 300 of FIG. 3, or (b) a Paragraph of 1 or more sentences in paragraph format, as illustrated in GUI 500 of FIG. 5. A set of problem data may also include one or more of:
a problem type indicating a comma problem with conjunctions or a comma problem with phrases and clauses;
markup of a comma problem sentence (as described in further detail below);
information that may be presented as hints;
grammatical roles played by structural elements in the problem, including independent clauses, dependent clauses, introductory elements, essential elements, nonessential elements, transitional terms, and subordinating conjunctions;
for each potential location in the sentences for a comma, a type of comma including placed or missing extraneous commas, placed or missing commas after an introductory element, placed or missing commas before or after a nonessential element, placed or missing commas before or after a transitional term, placed or missing commas between items in a list, and placed or missing optional commas;
for each potential comma location, a correction option including whether a missing comma needs a comma added, whether a placed comma is incorrect and should be removed, or whether a placed or missing comma is correct as-is;
relationships between potential comma locations and structural elements, including identifying an element before the potential comma location, identifying an element after the potential comma location, and identifying an element that encompasses the potential comma location, which may be expressed using offsets and/or pointers;
remediation information for incorrect corrections of each potential comma location, as necessary;
rule explanations and/or an explanation of the results from applying a rule, which are presented to the user after the problem is solved; and
for comma problems with conjunctions, a location and type of conjunction and relationships to the relevant potential comma locations;
a sentence type for affecting grammar skills, as discussed above in Section 1.0 of the parent provisional application, including: 1) a compound sentence joining two independent clauses, 2) a compound main clause with a preceding subordinate clause, 3) a compound main clause with a trailing subordinate clause, 4) a simple independent clause with a conjoined verb phrase, 5) an independent clause with a conjoined verb phrase and a preceding subordinate clause, 6) an independent clause with a conjoined verb phrase and a trailing subordinate clause, 7) a simple independent clause with a conjoined object noun phrase, 8) an independent clause with a conjoined object and a preceding subordinate clause, 9) a complex sentence with a main or independent clause first, 10) a compound main clause with subordinate clause modifying the first independent clause, 11) a complex sentence with a subordinate clause first, and 12) a sentence with no error, which may be further categorized as any of the preceding sentence types.

In some embodiments, some of the above metadata may not be explicitly specified by the problem writer. For example, if a compound sentence joining two independent clauses only contains correction options that indicate placed or missing commas correct as-is, then the sentence may automatically be categorized into sentence type 12, or a sentence with no error, without the problem writer having to explicitly specify as such in the metadata. The metadata may further categorize the sentence as sentence type 1, or a compound sentence joining two independent clauses, and identify the correct usage of the placed or missing commas in the sentence. In another example, the specific word offsets and/or pointers for the relationships between the commas and structural elements may also be calculated programmatically, rather than being explicitly specified by the problem writer. In yet another example, structural elements may be identified by using a parser or language analyzer.

To illustrate, database 140 may include, in connection with a particular set of problem data, metadata embedded into the following marked-up sentence:

```
$Moreover, [_indepClause]a college degree helps
  $developLeadership[/_indepClause][_missingComma/]
  [_relevantConj] [_coordConj] and[/_coordConj][/_relevantConj] [_indepClause]
  higher education is usually necessary for career advancement in business[_serial/],
  education[_serial/], [_conj]or[/_conj] the military[/_indepClause].
```

The embedded variables (“$Moreover”, and “$developLeadership”) facilitate creating alternate wordings for the marked-up sentence. For example, database 140 also includes the following definitions of the embedded variables:

```
‘Moreover’:RandomChoiceGenerator(choices=[‘In addition[_introPhrase/]’,
  ‘Moreover[_transitional/]’),
‘develop Leadership’: RandomChoiceGenerator(choices=‘[prepare individuals for
  leadership roles’, ‘develop leadership skills’]).
```

According to an embodiment, the variables are resolved before the sentence is stored at database 140.

In another embodiment, database 140 may include, in connection with a particular set of problem data, metadata embedded into the following marked-up sentence:

```
[_introElt]After$commaExtra1 this$commaIntroElt [_indepClause]$subject will have
  only $paymentType left[/_indepClause]. [_indepClause]$Subject will have only
  $paymentType left $commaExtra2 after this [/_indepClause].
```

Database 140 may also include the following definitions of the embedded variables:

```
‘Subject’: RandomChoiceGenerator(choices=[‘Our family’, ‘We’]),
‘subject’:TextGenerator(source=‘$Subject. lower( )’),
‘paymentType’: RandomChoiceGenerator(choices=[‘one car payment’, ‘two house
  payments’]),
‘commaExtra 1’: RandomChoiceGenerator(choices=[‘[_commaExtra/]’, ″]),
‘commaExtra2’: RandomChoiceGenerator(choices=[‘[_commaExtra/]’, ″]),
‘commaIntroElt’: RandomChoiceGenerator(choices=[‘[_commaIntro Elt/]’,
  ‘[_commaIntroEltSkip/]’]).
```

Thus, as illustrated above, the problems may be written with metadata to allow multiple alternative wordings. For example, different conjunctions, such as “and,” “or,” or “but” may be substituted as alternatives, commas may be placed or not placed according to random selection, different phrases may be selected at random, and structural elements may be rearranged into different orders within the sentence, allowing a wide range of possible problem sentences and sentence types to be generated from a small amount of metadata and/or variable definitions.

According to an embodiment, metadata for a sentence includes tags that grammar service 122 may use for remediation information. Such metadata identifies one or more portions of a sentence that are correct. For example, a particular marked-up sentence includes the metadata tag [_CorrectCommaIntroPhrase/], which indicates to grammar service 122 that a comma is located where the tag is positioned, and that the comma is correctly used to set off an introductory phrase. As described in further detail below, remediation service 128 may use such metadata to identify particular remediation information to display to a user. For example, if a user identifies the introductory phrase comma in a particular displayed sentence as an extraneous comma that should be removed, then remediation service 128 uses the tag that marks that comma to identify remediation text to display to the user. For example, the remediation text may indicate that the comma is being used correctly to set off an introductory phrase and should therefore remain.

### Comma Problem Categories

According to an embodiment, comma errors in database 140 are authored to present one of the following two categories: (a) a sentence list of two or more sentences that may each include zero or more comma errors; and (b) a paragraph of one or more sentences with zero or more comma errors. By presenting contrasting sentences in the (a) category, for example by using similar or contrasting sentence structures, the application of comma rules may become easier to understand for the user. The sentence sets may be written such that the subject matter or topic of each sentence is the same, with differences only in the grammatical structure affected by comma rules, thereby directing the user's focus. In one embodiment, the (a) category may be divided based on whether (1) a comma sets off a coordinating conjunction or (2) a comma only precedes or follows clauses and phrases. Further, the (a) category can be divided into discrete sections based on specific comma rules, providing logical separation for gradual mastery of comma rules, one subset of rules at a time.

Once a certain level of mastery is reached, then the user may move to questions in the (b) category, which presents a paragraph that may contain comma errors from multiple (a) sections. While the user moves from the (a) category to the (b) category in this particular example, alternative embodiments may change the ordering of question categories. In the (b) category, the paragraph may correspond to a subset of a longer paragraph, and the subset may be selected to respect sentence dependencies within the longer paragraph. For example, if the second sentence in the longer paragraph refers to the first sentence, such as by using a phrase similar to “as discussed above”, then the subset is selected such that the first and second sentences are either selected or omitted together.

The (b) category may demand more detailed answers from the user compared to the (a) category, which only asked the user to identify the presence or absence of comma errors. For example, for each sentence in the paragraph, the user may be asked to complete up to three tasks: 1) identify whether there is a comma error or not, 2) if there is a comma error, identify what the relevant correction is by identifying the specific comma to be removed or indicating the specific location to add a comma, and 3) in a sentence with a coordinating conjunction, determine whether the conjunction joins two independent clauses. For example, for each task, a list of possible alternatives with radio buttons may be presented, and the user may select the correct selection by clicking on the appropriate radio button. Other problem structures for comma errors may also be presented to users within embodiments. As the user progress through the above tasks, instructions 510 as shown in FIG. 5 may be updated to reflect the current task at hand.

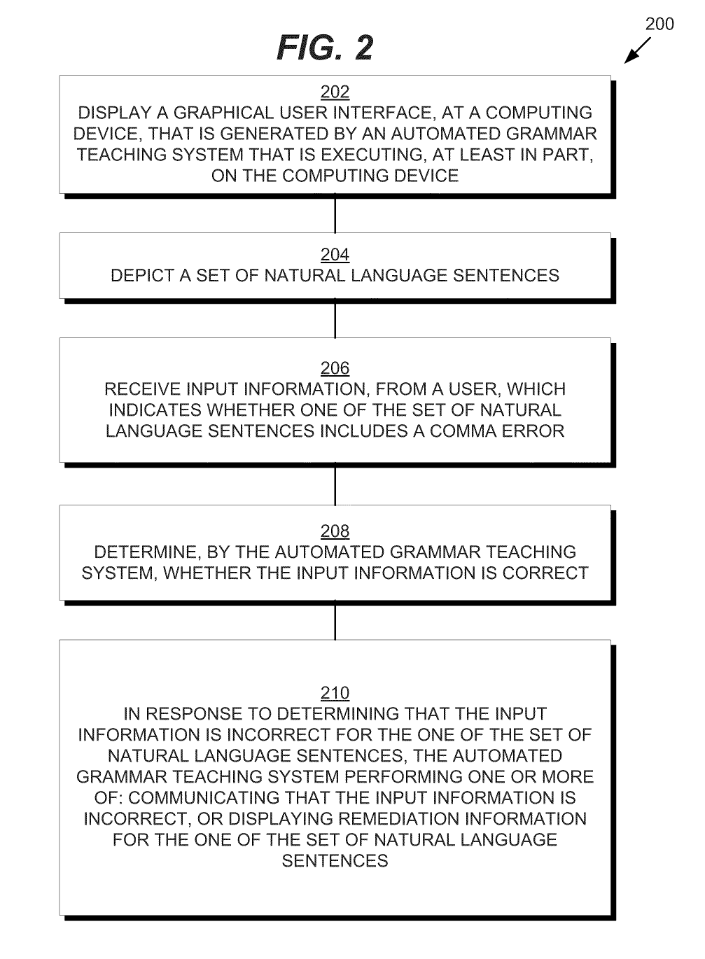

To identify the comma error in step 2) above, the user may for example click on a comma to be removed or click on a space between words to add a comma. In some embodiments, selections may be made by highlighting rather than single clicking, for example by clicking and dragging the desired selection. Grammar service 122 may utilize error location service 124 to identify the specific locations in the sentences that require the removal or addition of a comma, which may proceed similarly to the processes described in FIG. 2.2 and FIG. 2.3A-2.3B and related text in Section 2.0 of the parent provisional application. To assist the user in visualizing the impact of a potential modification, a preview of a corrected comma location may appear as the user moves a mouse pointer over a particular comma to be removed or a particular location to add a comma.

### Graphical User Interface Displaying a Sentence Set

FIG. 2 depicts a flowchart 200 for receiving input information from a user identifying comma errors in a displayed set of natural language sentences. At step 202 of flowchart 200, a graphical user interface is displayed at a computing device, which graphical user interface is generated by an automated grammar teaching system that is executing, at least in part, on the computing device. For example, in FIG. 1, web page 116 includes a graphical user interface such as GUI 300 of FIG. 3, which is generated by grammar service 122 executing on server device 120 or by grammar client 112 executing on client device 110.

Grammar service 122 sends information for GUI 300, via network 130, to grammar client 112. Grammar client 112 makes GUI 300 available to browser 114 executing on client device 110, and browser 114 displays GUI 300, e.g., in web page 116. According to another embodiment, grammar client 112 causes GUI 300 to be displayed outside of a browser, e.g., as part of a stand-alone application.

At step 204 of flowchart 200, a set of natural language sentences is depicted, wherein each sentence may include zero or more comma errors. To illustrate, GUI 300 depicts natural language sentences 302A and 302B that, according to an embodiment, include comma errors. According to another embodiment, sentences 302A and 302B may or may not contain a comma error, and grammar client 112 instructs users to determine whether each sentence includes a comma error, as shown by the “Correct” and “Incorrect” radio buttons.

As shown in FIG. 3, the example sentences 302A and 302B are chosen to illustrate differences in comma usage depending on whether a coordinating conjunction joins two independent clauses. Thus, sentence 302A, which has 1 independent clause and a phrase joined by the coordinating conjunction “and”, is contrasted with sentence 302B, which has 2 independent clauses joined by the coordinating conjunction “but”. By illustrating how comma usage changes based on the differences between the contrasting sentences, the comma rules may be easier to learn and understand.

According to an embodiment, a comma error may be categorized as one of the following two types: a missing comma error, or an extraneous comma error. For example, sentence 302A may have an extraneous comma error with an extraneous comma prior to the conjunction “and”, since the clause after the conjunction is only a phrase. On the other hand, since sentence 302B includes the conjunction “but” that joins two independent clauses, sentence 302B may have a missing comma error where a comma should be inserted prior to the conjunction “but”. However, embodiments are not limited to these two types of comma errors.

While the embodiment shown in FIG. 3 only asks the user to identify whether each sentence is correct as-is (“Correct”) or includes punctuation or comma errors (“Incorrect”), alternative embodiments may require the user to further identify the location and nature of any punctuation or comma errors. In this case, if a sentence includes multiple comma locations, then it is possible that (1) the user need only make a correction at one of the locations in order to correct the comma error; or (2) the user needs to make corrections at two or more of the locations in order to correct the comma errors. These corrections may be made, for example, by clicking on an existing comma to remove the comma, or by clicking at a specific location to insert a comma. Thus, embodiments may include sentences that have one or more comma errors, including missing and extraneous commas, which may be corrected by the user.

### Identifying Comma Errors in a Set of Sentences

At step 206, input information is received, from a user, which indicates whether the user believes that one of the set of natural language sentences includes a comma error. For example, grammar client 112 receives information, input by the user via GUI 300 that indicates whether natural language sentence 302A is “Correct” or “Incorrect”. A user may indicate this in various ways, such as by clicking on the radio buttons as depicted in GUI 300, by entering a particular key stroke (such as ‘C’, or ‘I’), etc.

FIG. 3 includes instructions 310 that instruct a user to determine whether the punctuation or comma usage is correct within sentence 302A. This depiction of instructions is non-limiting, and the instructions may be presented in other manners, with other wording, or may be entirely absent, within embodiments.

At step 208, the automated grammar teaching system determines whether the input information received from the user is correct. To illustrate, grammar client 112 sends the information indicating the selected choice of “Correct” or “Incorrect” for sentence 302A to grammar service 122. Grammar service 122 employs error correction service 126 to determine whether the user correctly identified whether comma error(s) are present. For example, error correction service 126 may examine the correction options in the metadata stored in database 140 for sentence 302A. If the correction options indicate required corrections for a sentence, then a user input of “Incorrect” is correct. If the correction options indicate that nothing needs to be corrected, then a user input of “Correct” is correct. Otherwise, if the user answers incorrectly compared to the correction options, then the user input is determined as incorrect. Step 208 may be carried out after the user provides input information for a particular problem step or task, and the user may be prevented from proceeding further until the user answers the particular problem step or task successfully.

Returning to flowchart 200 of FIG. 2, at step 210, the automated grammar teaching system performs one or more of the following actions in response to determining that the indicated input information is incorrect for one of the pair of sentences:
communicating that the indicated input information is incorrect;
displaying remediation information for the incorrectly indicated sentence.

For example, assume that the user has selected “Correct” for sentence 302A and “Incorrect” for sentence 302B. In this case, error correction service 126 receives input information indicating that the user has incorrectly identified that no comma errors exist for sentence 302A, but has correctly identified that comma errors exist for sentence 302B. As discussed above, these indications can be determined by examining the metadata in database 140.

According to an embodiment, in response to the above determination of error correction service 126, grammar client 112 communicates that the indicated input information is incorrect. For example, grammar client 112 displays text that informs the user that the user has not provided the correct selection for sentence 302A. As another example, grammar client 112 displays a symbol or plays a sound to indicate the incorrect selection for sentence 302A. As another example, grammar client 112 highlights instructions 310 within GUI 300 (e.g., with bolded text, font color, highlight color, a displayed symbol, a displayed border, etc.). Additionally or alternatively, portions of sentence 302A in GUI 300 may be highlighted in a similar manner, and grammar elements of sentence 302A may be identified with labels such as “introductory element”, “transitional term”, “conjunction”, and so forth.

### Hint Information

According to an embodiment, grammar client 112 displays hint information in response to detecting a user request for a hint, such as by the selection of hint button 312 (in GUI 300 of FIG. 3). Displayed hint information may be from one of various levels of hint information from the data for sentence 302A and 302B. Such levels may include (1) general instruction, (2) what concepts to think about for sentence 302A and 302B, and (3) what the correct answer is and why. Thus, as the user requests additional hints, the hints may progress from generalized rule statements to more specific instructions as applied to the specific problem at hand.

An initial hint may, for example, provide the general rule that “a comma is used when a coordinating conjunction joins two independent clauses”, without referring to the specific problem itself. A later hint may be focused on more specific concepts as applied to the problem. As illustrated in hint window 314, the clauses of sentence 302A and/or sentence 302B are underlined and identified for the user, providing a hint that the types of clauses in the sentence are important. A final hint may apply the general rule directly to sentence 302A and/or sentence 302B, providing an explicit explanation of the steps and concepts as applied. Thus, multi-level hints are provided with hints proceeding from general to specific.

To provide another example, for the sentence “After this our family will have only one car payment left”, hint information may be provided as follows:
Hint (1 of 4): Place a comma after an introductory element to let the reader know where the introductory element ends and the main part of the sentence begins.
Hint (2 of 4): To find the introductory element, try the removal tip: If an introductory element is removed from the sentence, what remains will still be a complete sentence.
Hint (3 of 4): If “After this” is removed, what remains is still a complete sentence. Place a comma after the introductory element.
Hint (4 of 4): Place a comma after the introductory element “After this” at the highlighted location.
   The user may move forwards and backwards through the hints as desired. In some embodiments, an auto-hint may be provided after a pre-determined number of incorrect user responses. For example, if the user submits 3 incorrect responses in a row for a particular problem or section, then a hint window may pop up automatically to assist the user.

Hints are presented in a contextually aware fashion, tailored according to the specific portion or step of the problem that the user is working with.

Additionally, in some embodiments, grammar client 112 may provide a just-in-time hint intervention after the user provides an incorrect response. The just-in-time hint may provide advice and guidance that targets common misconceptions related to the error that the user made. For example, if the user removes a correctly placed comma, then an explanation may be given as to why the comma should remain in the sentence. Similarly, if the user adds a comma to an incorrect location, then an explanation may be given as to why adding a comma would be inappropriate for that location.

### Correcting a Comma Error

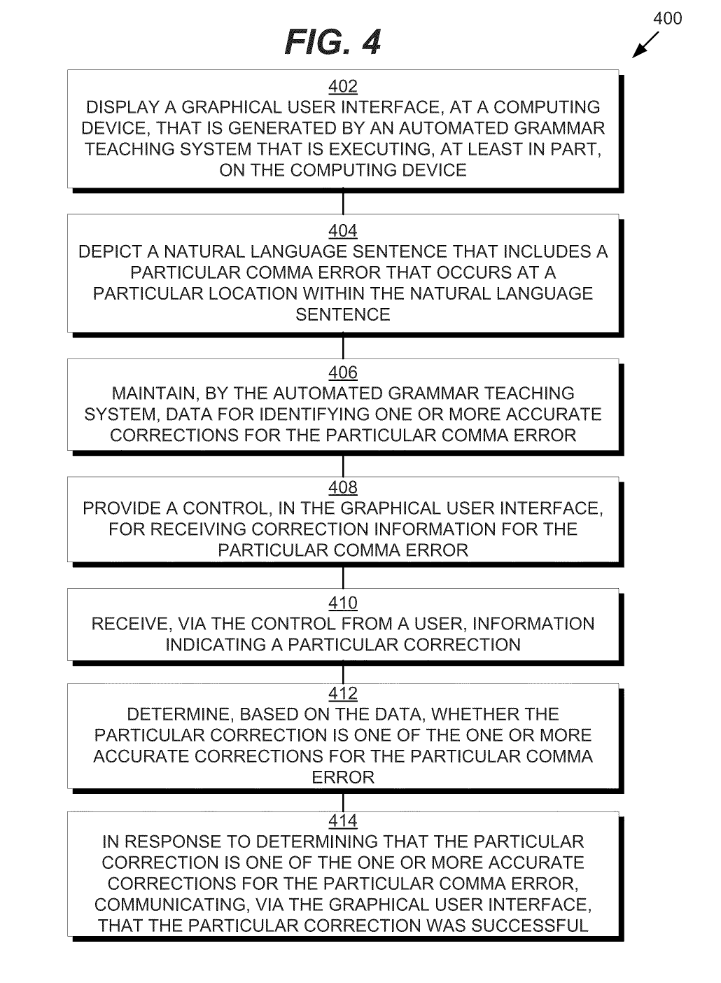

FIG. 4 depicts a flowchart 400 for receiving input information from a user identifying a correction of a comma error in a displayed natural language sentence and determining whether the correction is accurate. While the embodiment shown in flowchart 400 includes a single comma error in a sentence, other embodiments may include no comma errors or multiple comma errors in a sentence. At step 402 of flowchart 400, a graphical user interface is displayed at a computing device, which graphical user interface is generated by an automated grammar teaching system that is executing, at least in part, on the computing device. For example, web page 116 includes a GUI such as GUI 500 of FIG. 5, which is generated by grammar service 122 executing on server device 120 or by grammar client 112 executing on client device 110.

At step 404 of flowchart 400, a natural language sentence is depicted, which includes a comma error that occurs at a particular location within the natural language sentence. For example, GUI 500 depicts natural language sentence 504 that includes a comma error at location 530. While flowchart 400 concerns a natural language sentence with a single comma error, other embodiments may include natural language sentences with zero comma errors or multiple comma errors.

At step 406, the automated grammar teaching system maintains data for identifying one or more accurate corrections for the particular comma error. For example, database 140 includes a set of one or more accurate correction options for the particular comma error. Note that for a misplaced comma, two correction options may be present: one correction indicating an extraneous comma to be removed at the incorrect location, and another correction indicating a comma to be added at the correct location. To illustrate in the context of sentence 504, database 140 has information indicating that the following correction options are accurate for the comma error in sentence 302:
A placed comma at location 530 is an extraneous comma that should be corrected by removal.

At step 408, a control is provided, in the graphical user interface, for receiving correction information for the particular comma error. For example, grammar client 112 allows the user to click on a particular word corresponding to the conjunction relevant to the comma error.

At step 410, information indicating a particular correction is received via the control from a user. For example, as a part of identifying the comma error, the user may click on a particular word of sentence 504 shown in GUI 500 of FIG. 5 that is relevant to the comma error. In the example shown in FIG. 5, it can be seen that the user has clicked on the incorrect word 532, which is irrelevant to the comma error. Grammar client 112 receives information indicating that the user has clicked on word 532 and sends the information to grammar service 122.

At step 412, it is determined, based on the data, whether the particular correction is one of the one or more accurate corrections for the particular comma error. For example, grammar service 122 employs error correction service 126 to determine whether word 532 corresponds to a conjunction that has an associated comma error for sentence 504. Error correction service 126 examines the set of correction options, stored at database 140, that are accurate for the comma error in sentence 504.

Error correction service 126 compares word 532 to each of the accurate correction options stored at database 140 in turn. In most cases, there will only be one accurate correction option, but in some cases, for example in the case where an optional comma is indicated, multiple correct answers may be available. Since the metadata in database 140 may indicate that the conjunction with the comma error is the “and” located after the word “opportunities”, error correction service 126 determines that selecting word 532 is not an accurate correction. As a result, remediation information 520 may be presented to the user, as shown in FIG. 5.

At step 414, in response to determining that the particular correction is one of the one or more accurate corrections for the particular comma error, it is communicated, via the graphical user interface, that the particular correction was successful. Thus, assume that the user has backtracked and correctly selected “and” as the conjunction relevant to the comma error. Further, as previously discussed above, the user may be asked to justify the answer by selecting the correct comma rule that is being applied. In response, grammar client 112 may display text that informs the user that the user has accurately corrected the comma error in sentence 504. As another example, grammar client 112 displays a symbol, such as a green checkmark, or plays a sound to indicate to the user that the user has accurately corrected the comma error within sentence 504. As yet another example, grammar client 112 simply moves on to another problem or another portion of the present problem, such as another comma error within sentence 504, if any, or to a comma error in sentence 506, which communicates to the user that the user has accurately corrected any comma errors within sentence 504. Additionally, instructions 510 may be updated to reflect the successful correction and provide directions for sentence 506.

While the above example utilizes a sequential ordering for corrections, in some embodiments the user can choose any desired ordering for correcting multiple comma errors within the same sentence. Similarly, in some embodiments the user can choose any desired ordering for correcting multiple incorrect sentences within the same paragraph.

### Post Problem Teaching Comments

Rule explanations and/or teaching comments may be provided after a user has successfully solved sentence list problems. Rule explanations may be provided in the form of an on-screen character or avatar that coaches the user in a conversational style. After the user correctly answers a problem, the correct sentences may be displayed with the on-screen character commenting on how to apply the appropriate comma rule or rules for the displayed sentences.

For example, with a first sentence reading “After this, our family will have only one car payment left” and a second sentence reading “Our family will have only one car payment left after this”, an on-screen character may comment “Notice how moving the introductory phrase to a different part of the sentence means it no longer needs a comma”. Note that the teaching comment may not necessarily recite a specific grammar rule. This post-problem teaching comment or rule explanation may be recorded as part of the problem metadata, as discussed above, and may be specifically tailored to integrate the particular problem sentences, rather than providing a generic statement. Additionally, for each sentence the structure elements relevant to the rules may be highlighted (e.g., with bolded text, font color, highlight color, underlining, etc.) and labeled to facilitate identification by the user.

### Informal Teaching Comments

In some embodiments, these teaching comments rule explanations may be explained using informal rather than formal grammar terminology. For example, the formal rule that “a comma is used when a coordinating conjunction joins two independent clauses” may be difficult to understand if the user is unfamiliar with the grammar terminology used, such as “coordinating conjunction” or “independent clause”. In this case, a less formalized explanation may be provided in the hints, such as the informal explanation that “a comma joins clauses if each clause can stand alone as separate sentences.” A more detailed explanation might suggest to the user to “Try separating each clause before and after the ‘but’. If the clauses are readable as complete sentences, then a comma should be added before the ‘but’.”

### Remediation Information in Response to an Incorrect Selection

According to yet another embodiment, in response to the above determination of error correction service 126, grammar client 112 displays “remediation information” for the incorrectly indicated sentence. For example, remediation service 128 may use the metadata stored in database 140 to identify whether the insertion or deletion of a particular comma by the user is incorrect and to determine whether associated remediation information is available. In an embodiment, grammar client 112 presents a user with targeted remediation information about mistakes made by the user in identifying comma errors. Information on why the identified sentence is incorrectly indicated educates the user on proper comma usage, and therefore reinforces the user's knowledge of how to properly form sentences using commas.

Remediation information includes information that explains to a user why a particular sentence is incorrectly identified as having or not having a punctuation or comma error. According to an embodiment, database 140 stores remediation information, including text to be displayed, for each stored sentence. According to another embodiment, database 140 stores a collection of remediation information display text indexed by unique identifiers. In this embodiment, remediation information for a particular sentence references unique identifiers of remediation information stored in the collection, rather than directly embedding the remediation information with each stored sentence. In this manner, remediation information can be readily updated for all relevant problems, since only the text in the collection needs to be modified, rather than the embedded remediation information for each sentence.

Remediation information is created based on one or more of (a) academic literature about what students know and the mistakes that students make, (b) what subject matter experts and/or cognitive scientists know about how students learn, and (c) analysis of historical data gathered by grammar service 122. For example, grammar service 122 records, in historical data for a user, the mistakes that the user makes in identifying and correcting comma errors, and what, if any, remediation information grammar client 112 was presented to the user in response to detecting the mistake. Trends in the historical data may be identified at the individual user level and/or at larger group levels, e.g., by cognitive scientists, to determine what remediation information should be added to database 140.

Grammar client 112 displays remediation information when the user incorrectly identifies the presence or absence of a comma error for any of the sentences. As discussed above, this may be determined by examining metadata within database 140 for a sentence in question. Remediation information may be shown in a pop-up window, similar to remediation information 406 in GUI component 412 of FIG. 2.4, as discussed above in Section 2.0 of the parent provisional application. For example, if the user selects “Correct” for sentence 302B, which is incorrect, then the remediation information may underline and identify the clauses of sentence 302B as a first independent clause, a coordinating conjunction, and a second independent clause. The remediation information may then restate the general rule that a comma is required prior to a coordinating conjunction that joins two independent clauses, and ask the user to reconsider his answer. The user may close the pop-up window and proceed retrying the problem step. If the user is still confused, the user may request additional hints by clicking on hint button 312, as described above.

As discussed above, a just-in-time hint intervention may also be provided to remediate common misconceptions after the user submits an incorrect response. For example, a sentence may include a series of commas that are correctly used to separate items in a list. If the user attempts to remove any of these commas, then a just-in-time hint may appear, advising the user that “Commas are required between items in a list.”

According to this embodiment, database 140 contains remediation information for one or more of the following:
Identifying one of several classes of correct comma usage at the location of the error;
Identifying as the erroneously punctuated conjunction a word that is never a conjunction;
Identifying as the erroneously punctuated conjunction a word that is not a conjunction in this case but that is sometimes used a conjunction, such as “for”;
Identifying as the erroneously punctuated conjunction a conjunction that is correct without a comma because it is part of a dependent clause following an independent clause;
Identifying as the erroneously punctuated conjunction a conjunction that is correct without a comma because it connects a phrase that is not a complete clause;
Identifying as the erroneously punctuated conjunction a conjunction that correctly has a comma because it connects two independent clauses;
Identifying as the erroneously punctuated conjunction a conjunction that correctly has a comma because it follows an introductory dependent clause;
Identifying as the punctuated conjunction a conjunction that correctly has a serial comma because it is used with a list;
Attempting to correct the sentence by adding a comma when the correct solution is to delete a comma;
Attempting to correct the sentence by deleting a comma when the correct solution is to add a comma;
Attempting to correct the sentence by adding a comma after a conjunction rather than before it;
Attempting to correct the sentence by adding a comma where a comma does not to be added;
Attempting to correct the sentence by deleting a comma that is correctly used to separate a city and a state name;
Attempting to correct the sentence by deleting a comma that is correctly used to separate consecutive adjectives;
Attempting to correct the sentence by deleting a comma that is correctly used to separate two independent clauses joined by a coordinating conjunction;
Attempting to correct the sentence by deleting a comma that is correctly used to separate an introductory element from the rest of the sentence;
Attempting to correct the sentence by deleting a comma that is correctly used to set off a nonessential element, for example a “such as” phrase;
Attempting to correct the sentence by deleting a comma that is correctly used to set off a transitional term, for example “therefore”, “in addition”;
Attempting to correct the sentence by deleting a comma that is correctly used after an introductory dependent clause;
Attempting to correct the sentence by deleting a comma that is correctly used to separate elements in a list;
Attempting to correct the sentence by deleting a comma that is correctly used to separate two independent clauses with a conjunction;
Attempting to correct the sentence by adding a comma that is never appropriate;
Attempting to correct the sentence by adding a comma that is appropriate for some sentences but not for the particular sentence at hand.

### Sequence of Sentence List Problems

According to an embodiment, grammar client 112 may present a problem as a sentence list—i.e., a set of two or more sentences. The sentence list may include comma problems with conjunctions and/or comma problems with phrases and clauses. After reviewing the problems, the user may proceed to identify whether each sentence in the set of sentences is correct (no comma errors) or incorrect (has comma errors). As discussed above, if the user selects incorrectly, then remediation information or a just-in-time hint intervention may appear to teach the user the relevant comma-related rule. In some embodiments, the user may solve the sentences in any desired order. After all of the sentences are correctly identified, remediation information may be shown to explain to the user why the selections are correct. As discussed above, this explanation may include highlighting and labelling the relevant sentence structures in each sentence that pertain to the associated comma rules. Finally, the user may click the “I'm done” button to move onto the next problem.

### Sequence of Paragraph Problems

According to an embodiment, grammar client 112 may present a problem as a paragraph, where one or more sentences are shown in paragraph form. The paragraph may include sentences with conjunctions and/or sentences with phrases and clauses, but not every sentence necessarily includes a comma error. In the case of sentences with phrases and clauses, the user may be asked to identify whether a particular sentence has a comma error or no comma error. In the case of comma problems with conjunctions, the user may be asked to identify whether a particular sentence has a necessary comma that is missing, an incorrect comma that is present, or is correct as-is. If there is an error, the user may select a location within the particular sentence to remove an extraneous comma or to add a required comma. As discussed above, a misplaced comma may require correction at two locations: one correction to remove the misplaced comma and one correction to add the comma at the correct location. If the user submits an incorrect response, remediation information or just-in-time hint interventions may be provided. Grammar client 112 may also display auto-help information showing the correct location of a comma error once the user has selected a threshold number of incorrect locations, within a displayed sentence, that do not substantially match the correct location of a comma error within the sentence. After correcting all of the comma errors in the particular sentence, the user may then work on correcting comma errors in a different sentence. This process is then repeated until all comma errors are corrected in the paragraph. After each of the sentences is corrected, remediation information may be shown to explain to the user why the corrections are correct. As discussed above, this explanation may include highlighting and labelling the relevant sentence structures in each sentence that pertain to the associated comma rules. Finally, the user may click the “I'm done” button to move on to the next problem.

### Tracking and Using Historical Data

Grammar service 122 identifies which problem to display to a user based, at least in part, on user information stored at database 140. According to an embodiment, the automated grammar teaching system in FIG. 2.1 of the parent provisional application is configured to maintain historical data for a user, e.g., in a user profile for the user stored at database 140. Such historical data includes one or more of: previous problems that have been presented to the user, types of previous problems that have been presented to the user, correct and incorrect answers given by the user, timing of viewing and answering presented questions, etc.

Based, at least in part, on the historical data, grammar service 122 identifies problems, to present to the user, that target concepts within the grammar rules governing sentence types with which the user has not demonstrated mastery. The way that grammar service 122 interprets the data is configurable by an administrator of the system. For example, an administrator sets a rule in grammar service 122 that presents a specific set of problems until the user reaches a certain level of mastery, for example by mastering a certain percentage of skills tested in the set, or by attempting some maximum number of problems. Additional rules may present different sets of problems with similar criteria, allowing a lesson to be divided into several phases with different rules. For example, an initial phase may prefer to select problems that present a large number of skills that are not yet mastered by the user, whereas a later phase may prefer to focus on a smaller number of skills that need improvement.

According to embodiments:
A set of grammar skills that users are expected to master are identified, e.g., by cognitive scientists and/or subject matter experts;
Steps in individual problems are associated with particular grammar skills, e.g., by automated rules set by cognitive scientists and/or subject matter experts;
As the user progresses, the user's probability of mastery for each individual grammar skill is automatically calculated (according to Bayesian Knowledge Tracing), e.g., by grammar service 122; and
Problems that have associated grammar skills for which the user has not demonstrated mastery are automatically presented, until the user has mastered all of the grammar skills associated with available grammar problems, e.g., by grammar service 122.

In connection with sentences with comma errors, grammar service 122 may track grammar skills that are used in various ways by the sentence types listed above in the metadata stored in database 140.

### Corrections of Multiple-Sentence Paragraphs

According to an embodiment, at least some of the problems in database 140 include data for multiple sentences that are configured to be presented all together to a user, i.e., in paragraph form. For example, FIG. 5 depicts a GUI 500 in which a paragraph 502 is displayed, having sentences 504 and 506. In the embodiment of GUI 500 of FIG. 5, grammar client 112 causes each sentence to be highlighted in turn, and allows a user to determine whether the highlighted sentence includes a comma error. This determination may be provided by the user by a multiple choice selection. The user may be asked to complete various tasks for a particular sentence, such as sentence 504, prior to moving on to another displayed sentence (e.g., sentence 506). For example, as discussed above, the user may be asked to 1) identify whether a comma error exists, 2) locate the comma error if one exists, and 3) determine whether a conjunction joins two complete sentences.

For example, after sentence 504 is highlighted, the user may be given a choice to select 1) a comma should be inserted into sentence 504, 2) a comma should be deleted from sentence 504, or 3) sentence 504 is correct as-is. If the user correctly determines that there is not a comma error and chooses selection (3), then grammar client 112 highlights the next sentence, if there is one, and continues as with the first highlighted sentence. However, if a comma error does exist, then the user must select either selection (1) or (2) depending on the appropriate correction. If the user chooses selection (1), instructions 510 direct the user to identify the location to insert the comma, or more specifically to choose the conjunction relevant to the comma error.

As shown in FIG. 5, the user has selected the incorrect word 532 as relevant to the comma error, and a remediation message 520 is shown to the user. The user may request additional hints or dismiss remediation message 520 and retry. After the user selects the correct conjunction, “and”, then the user is prompted to indicate (1) whether the words before the relevant conjunction could stand as a complete sentence, and (2) whether the words after the conjunction could stand as a complete sentence. Then the student is prompted to click on the location at which a comma is to be removed (or alternatively in another embodiment, inserted). The student may move to sentence 506 once the student has successfully responded to this prompt.

Providing the user multiple sentences in the form of a paragraph gives the user a more realistic simulation of applying comma rules in the real-world setting of drafting and editing a paragraph. Users must be able to apply comma rules in the context of a multiple-sentence paragraph, as displayed in GUI 500. These problems may contain multiple sentence types, multiple comma errors, and complex sentences with multiple potential locations for comma errors. Thus, completing paragraph-style problems as in GUI 500 can help better prepare such users to correctly apply comma rules in prose-style writing assignments and other writing opportunities.

### Intelligent Tutoring System for Automatically Teaching Grammar

According to an embodiment, grammar service 122 and/or grammar client 112 is implemented as part of an intelligent tutoring system, such as the cognitive tutor described in Koedinger, K. R., Anderson, J. R., Hadley, W. H., & Mark, M. A. (1997), Intelligent tutoring goes to school in the big city, International Journal of Artificial Intelligence in Education, 8, 30-43, and Anderson, J. R., Corbett, A. T., Koedinger, K. R., & Pelletier, R. (1995), Cognitive Tutors: Lessons Learned, The Journal of the Learning Sciences, 4(2), 167-207, both of which are incorporated herein by reference.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

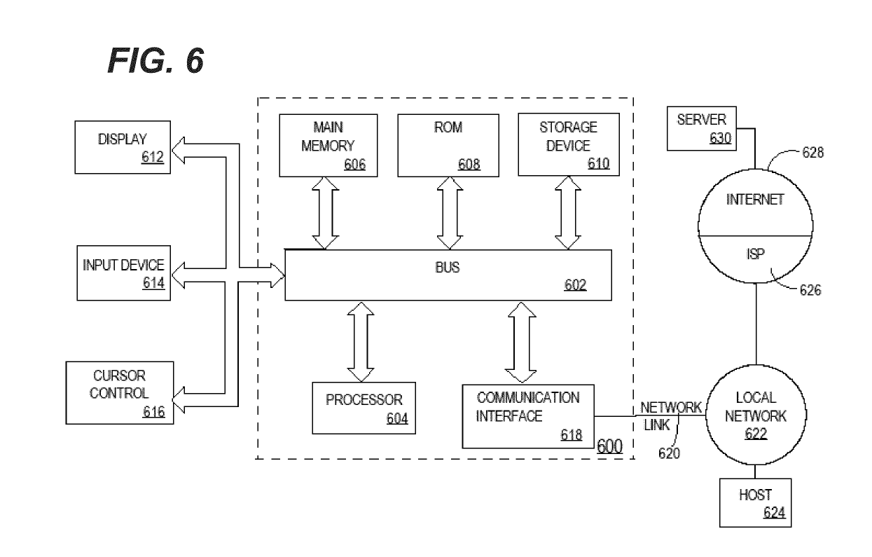

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
displaying a graphical user interface that is generated by an automated grammar teaching system that is executing, at least in part, on a computing device;
depicting a set of natural language sentences on the graphical user interface, wherein the set of natural language sentences have differences in grammatical structure affected by one or more comma rules;
receiving input information, from a user, which indicates whether one of the set of natural language sentences includes a comma error;
determining, by the automated grammar teaching system, whether the input information is correct;
in response to determining that the input information is incorrect for one of the set of natural language sentences, the automated grammar teaching system performing one or more of:
communicating that the input information is incorrect, or
displaying remediation information for the one of the set of natural language sentences.

2. The method of claim 1, wherein the set of natural language sentences use similar or contrasting sentence structures.

3. The method of claim 1, further comprising, prior to the receiving: communicating one or more hints for the one of the set of natural language sentences in response to a hint request from the user.

4. The method of claim 1, wherein the remediation information comprises identifying one or more grammar elements of the one of the set of natural language sentences.

5. The method of claim 4, wherein the one or more grammar elements include one or more phrases, independent clauses, dependent clauses, introductory elements, essential elements, nonessential elements, transitional terms, or subordinating conjunctions.

6. The method of claim 4, wherein the identifying includes underlining and displaying names of the one or more grammar elements in the graphical user interface.

7. The method of claim 1, further comprising:
recording, in a set of historical data for the user, information about the depicted set of natural language sentences and the indicated input information;
based, at least in part, on the set of historical data for the user, selecting a second set of natural language sentences; and
displaying a second graphical user interface, at the computing device, that depicts the second set of natural language sentences.

8. A computer-executed method comprising:
displaying a graphical user interface, at a computing device, that is generated by an automated grammar teaching system that is executing, at least in part, on the computing device;
depicting a natural language sentence that includes a particular comma error that occurs at a particular location within the natural language sentence;
maintaining, by the automated grammar teaching system, data for identifying one or more accurate corrections for the particular comma error;
providing a control, in the graphical user interface, for receiving correction information for the particular comma error;
receiving, via the control from a user, information indicating a particular correction;
determining, based on the data, whether the particular correction is one of the one or more accurate corrections for the particular comma error;
in response to determining that the particular correction is the one or more accurate corrections for the particular comma error, communicating, via the graphical user interface, that the particular correction was successful.

9. The method of claim 8, wherein the data for identifying the one or more accurate corrections include, for each potential location for a comma in the natural language sentence, whether:
a missing comma needs a comma added,
a placed comma is incorrect and needs to be removed, or
a placed or missing comma is correct as-is.

10. The method of claim 8, wherein the information indicating the particular correction includes a selection of a conjunction, in the depicted natural language sentence, that is relevant to the particular comma error.

11. The method of claim 10, wherein the information indicating the particular correction includes indicating whether or not the conjunction joins complete sentences.

12. The method of claim 8, further comprising, prior to the receiving:
providing an auto-hint after receiving a pre-determined number of incorrect corrections from the user.

13. The method of claim 8, further comprising, prior to the receiving:
displaying a preview of a candidate correction applied to the natural language sentence, the candidate correction based on a position of a pointer in the graphical user interface.

14. The method of claim 8, further comprising, after the determining:
showing a just-in-time hint in response to determining that the particular correction is not the one or more accurate corrections for the particular comma error.

15. The method of claim 8, wherein the depicting of the natural language sentence comprises the graphical user interface highlighting the natural language sentence within a paragraph, the highlighting by one or more of bolded text, font color, highlight color, a displayed symbol, labels, explanatory text, or a displayed border.

16. The method of claim 15, wherein the communicating comprises the graphical user interface highlighting a different natural language sentence within the paragraph.

17. The method of claim 8, wherein the remediation information is based on one or more of:
academic literature about what students know about commas and the mistakes students make about commas;
cognitive learning models from subject matter experts and/or cognitive scientists; or
a recorded set of historical data for the user.

18. A non-transitory computer-readable medium storing one or more sequences of instructions which, when executed by one or more processors, cause performing of:
displaying a graphical user interface, at a computing device, that is generated by an automated grammar teaching system that is executing, at least in part, on the computing device;
depicting a set of natural language sentences, wherein the set of natural language sentences have differences in grammatical structure affected by one or more comma rules;
receiving input information, from a user, which indicates whether each of the set of natural language sentences includes a comma error;
determining, by the automated grammar teaching system, whether the input information is correct;
in response to determining that the input information is incorrect for one of the set of natural language sentences, the automated grammar teaching system performing one or more of:
communicating that the input information is incorrect,
displaying remediation information for the one of the set of natural language sentences.

19. The non-transitory computer-readable medium of claim 18, wherein the set of natural language sentences use similar or contrasting sentence structures.

20. The non-transitory computer-readable medium of claim 18, wherein the remediation information comprises identifying one or more grammar elements of the one of the set of natural language sentences.
